(19) United States
(12) Patent Application Publication
(10) Pub. No.: US 2006/0153741 A1
(43) Pub. Date: Jul. 13, 2006

(54) Micro fluidic control device and process for producing the same

(75) Inventor: Yoshikazu Yoshida, Saitama (JP)

Correspondence Address: BIRCH STEWART KOLASCH & BIRCH, PO BOX 747, FALLS CHURCH, VA, 22040-0747, US

(73) Assignee: TAMATA-TLO Corporation, Hachioji-shi (JP)

(21) Appl. No.: 10/534,799

(22) PCT Filed: Nov. 14, 2003
(86) PCT No.: PCT/JP03/14505

§ 371 Date: Nov. 21, 2005

(30) Foreign Application Priority Data
Nov. 15, 2002 (JP) 2002332763

(51) Int. Cl. B01L 3/00

(52) U.S. Cl. 422/100; 137/833; 427/2.11; 156/60; 156/272.8

(57) ABSTRACT

A microfluidic device comprising a substrate, a plurality of resin layers formed on the substrate, and a three-dimensional fluid circuit formed on each of the plurality of the resin layers; and a method of manufacturing a microfluidic device comprising the steps of (a) forming a resin layer on a substrate and forming a groove having a predetermined pattern which functions as a fluid flow path by removing the resin layer by laser processing, (b) forming a subsequent resin layer by coating a resin on the overall surface of the resin layer having been processed and forming a groove and/or a throughhole to the groove formed in the resin layer coated with the resin, by laser processing of the subsequent resin layer, (c) repeating the step (b), and (d) forming a three-dimensional fluid circuit by finally resin coating.

### TECHNICAL FIELD

The present invention relates to a microfluidic device for effecting a so-called μ-TAS (Micro Total Analysis System) and a method for producing the same.

### BACKGROUND ART

Conventionally, in various fields, fluid components must be analyzed in particular facilities, which requires much time to analyze them. To cope with the above problem, there are increasing needs for small, highly sensitive microfluidic devices and micro total analysis systems (μ-TAS), which are miniaturized to a card size and have a separator, a mixer, a sensor, and an analyzer integrated with each other in a micro size, have been developed. The μ-TAS for analyzing fluid components employs a microfluidic device.

In the typical structure of the conventional μ-TAS, a micro-channel, a sampling section, a filter, a column, and a detector are miniaturized and integrated on a substrate. The analysis using the μ-TAS requires less space, power, time, specimen, reagent, and the like.

There have been increased needs for developing miniature devices and highly sensitive detecting methods in recent years, aimed at analyzing the components of trace fluids, such as DNAs and toxic substances, in various fields, including studies of genes and criminal investigations. For high-accuracy analysis using a small amount of a sample, spectral analysis methods, such as a fluorometric analysis method, which are used most widely at present, have many deficiencies. There has been no report concerning merits in the point of detection sensitivity even if the device is miniaturized. On the other hand, it can be expected that the μ-TAS enables measurement using only a small amount of the sample or the reagent.

Also, in medical fields, very expensive and large-scale biochemical analyzers are inevitably used as the last resort for measurements of various parameters, such as various proteins, hormones, and antigen antibodies, including counting of numbers of red blood corpuscles or white blood corpuscles. Study is proceeding to apply the μ-TAS to such measurement as this, thereby carrying out such analysis and measurement inexpensively and promptly, with high sensitivity. Moreover, the use of the μ-TAS enables simplifying the exchange of parts, and freedom from concern about infection in blood analysis, and such use is expected to contribute to the development of sanitation in medical fields.

The μ-TAS is expected to play an active role part in the field of genetic information (DNA) analysis, which is being studied most popularly in many countries, including the U.S., besides the aforementioned fields. Experiments have been made aiming at, as one of their final targets, performing treatment fitting to an individual, and that treatment would be realized by decoding the DNA of the human completely to find the causes of intractable diseases at the gene level. For this purpose, μ-TAS technologies are also expected from the viewpoint of decoding genes on the level of an individual rapidly and precisely.

As for the system itself, the μ-TAS can be small-sized, it can be produced at low cost, and it can reduce dead volume. Also, it can remarkably decrease the amounts of samples and reagents required for measurement, and also the amount of waste generated in analysis. These many advantages of the μ-TAS allow it to be expected to be applied and developed in various fields.

As a μ-TAS like this, one provided with miniaturized channels, and analyzing and detecting sections, which are combined and secured to a substrate, is conventionally proposed.

In such a conventional μ-TAS, it is required to wash the whole system each time it is used, or it is required to dispose of it, particularly in medical fields, and analysis of genetic information. However, the μ-TAS like this is itself a very expensive miniature system, and it is therefore desired to develop systems and devices that are not all disposed of after each use.

On the other hand, attention has been focused on processing of resin with a laser as a method of forming a micro-structure. A channel pattern of a microfluidic device can be drawn with a single stroke of the brush at a high speed making use of a laser. Further, a stepped or inclined micro-channel can be formed by laser scanning the channel at an accelerated speed. Further, micro processing, which is less influenced thermally by ablation, can be expected by using an ultraviolet laser (refer to, for example, “The Physics and Technology of Microfabrication” Yoshikazu Yoshida, Mar. 25, 1998, Shokabo, Tokyo).

There is also developed a microfluidic device capable of μ-TAS that can be reproduced and reused without being discarded each time it is used for measurement and analysis even if it becomes polluted thereby. The microfluidic device has a substrate, on which flow paths (grooves) and the like, acting as the components of μ-TAS, are formed using a laser. The substrate includes resin layers and resin coats covering the resin layers wherein fluid circuits are formed in the resin layers (refer to, for example, Japanese Patent Unexamined Publication 2002-283293).

When fluids are mixed in the conventional microfluidic device, the fluids are introduced into flat mixing flow paths as shown typically in FIGS. 8(a) and 8(b) from separate fluid introduction ports 51 and 52 (refer to FIG. 8(a)). After the flow paths merge with each other, particles 55 of substances contained in the respective fluids are migrated as shown by arrows and mixed by an action of a comb-shape electrode 53 (refer to FIG. 8(b)), and the mixed fluid is discharged from a discharge port 54.

However, electric energy is required in the above mixing method. Further, substances to be mixed are limited only to the substances in which electric migration occurs.

Other and further features and advantages of the invention will appear more fully from the following description, taken in connection with the accompanying drawings.

### BRIEF DESCRIPTION OF THE DRAWINGS

FIG. 1(a), 1(b), 1(c), 1(d), and 1(e) are explanatory views illustrating an example of a step of producing a microfluidic device according to the present invention.

FIG. 2 is a view explaining an example of a micro-channel constituting the microfluidic device.

FIG. 3(a) is a perspective view of the micro-channel constituting the microfluidic device of an example 1, and FIG. 3(b) is a sectional view of a merge portion of the micro-channel.

FIGS. 4(a), 4(b), 4(c), 4(d), and 4(e) are views explaining micro-channel forming processes in the example 1.

FIG. 5(a) is a perspective view of a micro-channel constituting a microfluidic device of an example 2, and FIG. 5(b) is a sectional view of a merge portion of the micro-channel.

FIGS. 6(a), 6(b), 6(c), and 6(d) are views explaining micro-channel forming processes in the example 2.

FIG. 7 is a view explaining a fluid mixing method making use of a shape of the microfluidic device.

FIGS. 8(a) and 8(b) are views explaining an electric mixing method of fluids in the microfluidic device.

### DISCLOSURE OF THE INVENTION

According to the present invention, the following measures are provided:

(1) A microfluidic device, comprising a substrate, a plurality of resin layers formed on the substrate, and a three-dimensional fluid circuit formed in the plurality of the resin layers.

(2) A method of manufacturing a microfluidic device, comprising the steps of:

(a) forming a resin layer on a substrate, and forming a groove having a predetermined pattern which functions as a fluid flow path by removing the resin layer by laser processing;

(b) forming a subsequent resin layer by coating a resin on the overall surface of the resin layer having been processed, and forming a groove and/or a throughhole to the groove formed in the resin layer coated with the resin, by laser processing of the subsequent resin layer;

(c) repeating the step (b); and

(d) forming a three-dimensional fluid circuit by finally forming inlets and an outlet by resin coating.

(3) The method of manufacturing the microfluidic device according to the item (2) described above, wherein the resin layer is formed by a lamination method.

(4) The method of manufacturing the microfluidic device according to the item (2) described above, wherein the resin layer is formed by a spin coat method.

A microfluidic device of the present invention is used in the μ-TAS.

### BEST MODE FOR CARRYING OUT THE INVENTION

The present invention will be described in detail below.

The method of producing the microfluidic device according to the present invention will be first explained with reference to the drawings.

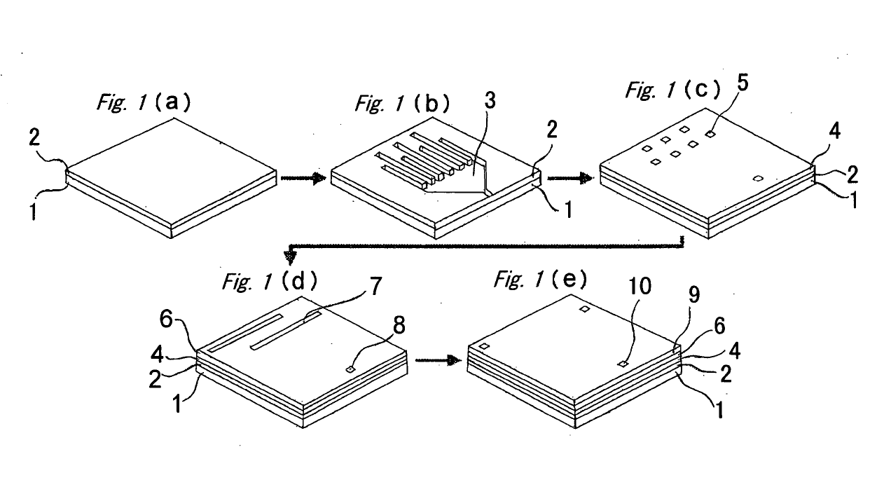

FIGS. 1(a) to 1(e) show an example of a process for manufacturing a microfluidic device according to the present invention. Fluids are transported, mixed, stirred, separated, and the like in a three-dimensional fluid circuit (hereinafter, referred to as a micro-channel) constituting the microfluidic device. A three-dimensional merging channel is made by forming a plurality of layers of a thermosetting laminate film on soda glass and forming a part of the channel in each of the layers with a laser.

FIG. 1(a) is a perspective view showing a state in which a first resin layer 2, which will be described later, is laminated on a substrate 1 such as the soda glass and the like. FIG. 1(b) shows a state in which a groove 3 is formed by processing the first resin layer 2 with a laser beam at a laser processing step. No particular limitation is imposed on a method of forming the channel by the laser light. As for example, there are a method in which a laser source is moved to carry out scanning exposure in accordance with an object circuit pattern (the width and depth of a groove and the shape of a circuit) to be formed, and a method in which the laser source is fixed, and the substrate 1 is made to travel relatively to the laser light, such that a pattern in accordance with an object circuit is formed.

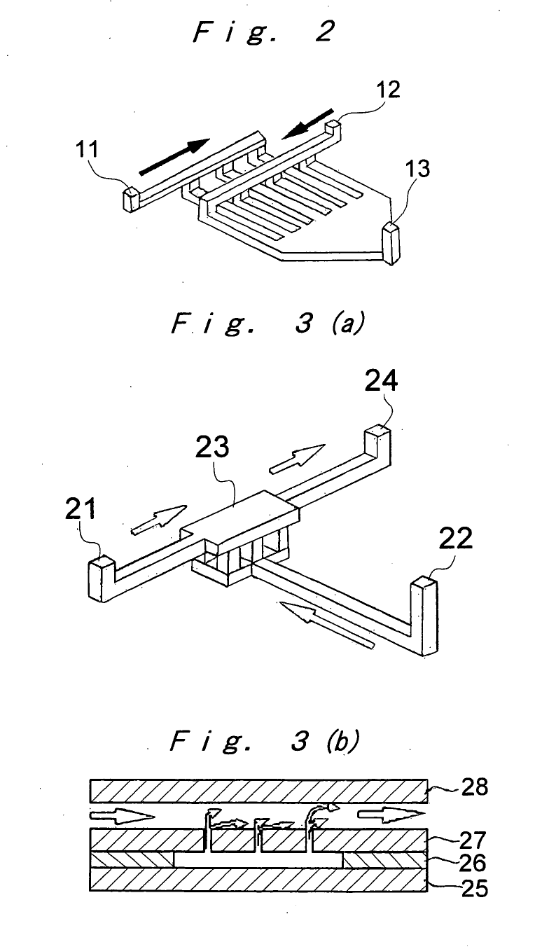

Next, as shown in FIG. 1(c), a second resin layer 4 is formed by laminating it on the resin layer having a flow path composed of the groove 3 so as to cover the entire component, and throughholes 5 are formed to the second resin layer 4 by subjecting it to laser processing likewise the first layer. Next, as shown in FIG. 1(d), after a third resin layer 6 is laminated likewise, a groove 7 and a throughhole 8 are formed by subjecting it to laser processing. Further, as shown in FIG. 1(e), after a fourth resin layer 9 is laminated likewise, throughholes 10 are formed by subjecting it to laser processing. A micro-channel having an inlet All, an inlet B12, and an outlet 13 is formed by the processing steps described above, as shown in the perspective view of FIG. 2.

As a substrate of the present invention, such plastics as Teflon (trade name, polytetrafluoroethylene) and the like, besides such inorganic materials as soda glass, silicon, quartz glass, ceramics, and metals, may be used. In the case of conducting analysis by applying light from the side (lower surface) opposite to the surface of the microfluidic device, on which surface the circuit is formed, it is preferable to use a light-transmittable material, such as quartz, as the substrate. Although no particular limitation is imposed on the thickness of the substrate, the thickness is preferably in a range from 0.1 to 5 mm, and more preferably in a range from 0.4 to 1 mm.

Although there is no particular limitation also to the thickness of the resin layer to be applied to the substrate, the thickness is preferably 10 to 1000 μm, and more preferably 20 to 50 μm. The thickness of the resin layer is determined depending upon the type of the measurement, and the amount of the sample required for the measurement. When the thickness is excessive, it is difficult to carry out laser processing, whereas when the thickness is too thin, a fluid, such as a sample solution, does not flow. As the resin to be used, any one of resins that are easily applied to the substrate by a spin coating method, laminating method, or the like, not reacting with a sample for analysis and elute in the sample, may be used. The resins that can be washed away with ease after it is used are preferable so as to reduce costs and simplify the washing and exchange of the resin. The use of such a resin ensures that not all of the parts have to be disposed of, and it is sanitary which enables the silicon substrate to be reused.

As the resin, any resin may be used as long as it satisfies the above requirements. Examples of the resin include thermosetting resin, such as polyimide, benzocyclobutene resin (BCB) and fluorocarbon resins, such as Teflon (trade name, polytetrafluoroethylene). The thickness of the resin layer 2 is usually designed to be the same as the depth of the groove 3 of the channel. However, the resin may be left partially, according to the function of some parts of the channel circuit. Also, in the case of carrying out photo detection, even if the resin is left partially, this is no problem as long as the size of the residual portion is less than the wavelength of the detection light.

The processing for forming the channel in the resin layer is preferably performed by laser processing. As the laser, an ultraviolet laser is preferable.

Processing of less thermal effects can be attained by processing using ultraviolet light. In mechanical processing and the like, it is difficult to carry out precise processing due to strain or damage caused by heat. However, the processing using the ultraviolet laser decreases the generation of heat, thereby suppressing the reduction in accuracy caused by the heat of the processed material. Further, the convergency of the laser is largely dependent on its wavelength, and the shorter the wavelength is, the better the convergency is. Therefore, the processing using the ultraviolet laser may be utilized for precise processing and fine processing for which high accuracy is needed. Also, the resistance to the generation of heat makes it possible to process materials such as resins, which are easily affected by heat.

Among these ultraviolet laser lights, a preferable ultraviolet laser light has a wavelength ranging preferably from 350 nm or less, and more preferably from 150 to 300 nm.

In the case of processing using ultraviolet laser light in the present invention, it is considered that the groove is formed by a laser ablation phenomenon. This mechanism is considered to be as follows. When a macromolecular material is irradiated with an ultraviolet laser, a molecular bond is cut, and the material is vaporized. (a) When, first, the macromolecular material is irradiated with an ultraviolet laser having, for example, a wavelength of 250 nm, for several tens ns, (b) excited molecules and various activated species are generated at high density on the surface of the macromolecular material. (c) When the energy received from the laser by the molecule is greater than that required for the chemical bond constituting the molecule (when the energy exceeds the work threshold that is the value intrinsic to the material), the chemical bond is cut, and the material is decomposed at the molecular or atomic level. This causes rapid volumetric expansion. (d) At this time, the energy given excessively is converted into kinematic energy of the molecule, and the molecule is ejected into an open space above the processed material, and is therefore removed.

Since there are several types of the lamination method to form the resin layers by resin coating, any type of the lamination methods may be used. As a specific example of the method, extrusion lamination, dry lamination, and wet lamination are typical in the case of laminating a plastic film. A laminated film composed of polyimide provided with an epoxy-series adhesive layer, and the like, for example, is exemplified as the plastic film.

It is preferable in the present invention to form a groove by a laser in the plastic film laminated on the substrate and to further laminate a plastic film thereon. In this case, a groove and a hole are also formed in the latter laminated plastic film. A plastic film is further laminated and a groove and a hole are also formed thereto. It is preferable to form the microfluidic device by forming a three-dimensional flow path in the structure of layers formed by laminating plastic films by repeating the above process, forming a cover finally by laminating a plastic film, and forming inlets and an outlet.

When the resin layer subsequently laminated is processed with an ultraviolet laser, the resin layer can be processed up to the interface thereof by appropriately selecting processing conditions such as a wavelength, pulse energy, a pulse width, the number of repetition, and the like, thereby a groove can be formed in the resin layer or a throughhole passing through the groove formed in the laminated resin layer can be formed.

The resin layer may be formed by a conventional spin coat method in place of the laminate method described above.

The microfluidic device having the substrate and the plurality of resin layers, which are formed on the substrate and in which the three-dimensional fluid circuit is formed integrally with the plurality of resin layers, is manufactured by the method described above.

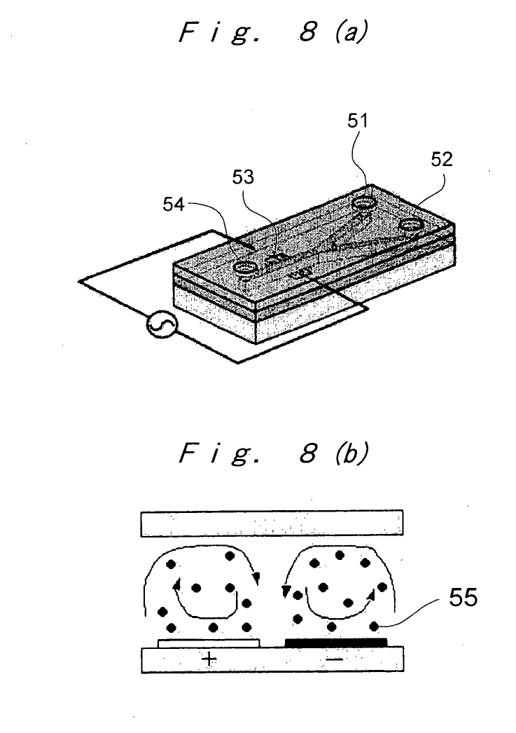

The three-dimensional flow circuit of the present invention is preferably a three-dimensional mixing flow path. A minute amount of a fluid A (41) and a minute amount of a fluid B (42) are introduced by minute amount fluid feed pumps and the like from the separate inlets of the microfluidic device having the three-dimensional mixing flow path. Then, for example, as shown in FIG. 7, the fluids A and B are fed in the directions of arrows making use of three-dimensional flow path at the migrating portion, thereby the substances contained in the respective fluids A and B can be uniformly mixed. As described above, the minute amounts of solutions, the uniform mixing of which is difficult up to now, can be mixed promptly by providing branches and the migrating portion. This method does not require electric energy in mixing different from the electric method shown in FIGS. 8(a) and 8(b).

The substances mixed by the present invention may be substances between which a reaction occurs, and a reaction speed can be more accelerated than the conventional electric mixing method.

Although the fluids mixed in the three-dimensional mixing flow path are not particularly limited, for example, samples of blood, reagent solutions used in analysis, and the like can be exemplified.

In the present invention, it is preferable to form the micro flow path having the depth of 20 to 30 μm and the width of 20 to 100 μm in the resin portion to realize a card-sized μ-TAS. The following advantages can be obtained by creating the micro flow path by the resin laser ablation method: 1. the resin can be processed easily; 2. the three-dimensional structure can be created; and 3. the pattern can be removed using a mask.

The microfluidic device of the present invention may be applied to known various types of μ-TAS, as mentioned in the paragraph “BACKGROUND ART.” Some-examples of detection methods used in these types of μ-TAS will be explained.

1) Electrochemical Detection Method

This detection method is suitable to the present invention from the viewpoint of integrating a chemical system on one substrate, because the detecting part is also integrated on the substrate. The microelectrode can be produced easily on the substrate by using micromachining technologies. This detection method also requires no light source, and it can be an ideal detection method for microchemical systems.

2) Chemiluminescence Method

This detection method utilizing chemiluminescence requires neither an external light source, such as a laser, nor a complex optical system, such as a microscope, because the reaction system itself emits light, and the method only requires a highly sensitive photodetector. Therefore, this detection method is an ideal method to integrate, as in the case of a microelectrode.

3) Electrochemiluminescence Method

This electrochemiluminescence method can control chemiluminescence by applying voltage to an electrode, and therefore it is simple and ensures reliable results.

The microfluidic device of the present invention can be restored to the original silicon substrate by washing the resin layer using a solvent.

The flow path with the three-dimensional structure having the branch portion and the merge portion can be formed in the microfluidic device according to the present invention, thereby a plurality of solutions can be mixed as well as the reaction speed thereof can be accelerated.

The present invention will be described in more detail based on examples given below, but the present invention is not limited by these examples.

### EXAMPLES

### Example 1

A substrate to be processed was composed of soda glass (thickness: 1.3 mm) on which a thermosetting film (Nikaflex (trade name) manufactured by Nikkan Industries) was laminated. The laminated film was composed of a polyimide layer of 25 μm thick on which an epoxy adhesive layer of 20 μm thick was bonded.

There was used a pulse Nd: YAG laser processing machine (Brilliant (trade name) manufactured by Quantel). Processing conditions were set to a wavelength of 266 nm, pulse energy of 3.1 mJ, a pulse width of 4.3 ns, and the number of repetition of 10 Hz. A laser beam was fixed, and the substrate to be processed was moved by an XY stage having a positioning accuracy of 5 μm. The processing machine moved a material to be processed at a speed of 81 μm/sec and had a circular converging shape of 35 μm in diameter.

Channels (flow paths) each having a width of 20 to 100 μm and a depth of 20 to 30 μm of a microfluidic device was processed to a resin portion using the fourth harmonic (266 nm) of YAG laser, thereby the microfluidic device having a micro channel shown in FIG. 3(a) was made. In FIG. 3(a), reference numeral 21 denotes an inlet A, 22 denotes an inlet B, 23 denotes a merge portion and 24 denotes an outlet. Fluids introduced from the inlets travel in the directions of arrows. Further, FIG. 3(b) shows the sectional view of the merge portion 23. Reference numeral 25 denotes a substrate, 26 denotes a first resin layer, 27 denotes a second resin layer, and 28 denotes a fourth resin layer. The fluid, which was introduced from the inlet B 22 by being applied with pressure, flew in the channel formed in the first layer, passed through the throughhole formed in the second layer at the merge portion, was mixed with the fluid from the channel inlet A 21 formed in a third layer, flew in the direction of the arrow, and was discharged from the outlet 24.

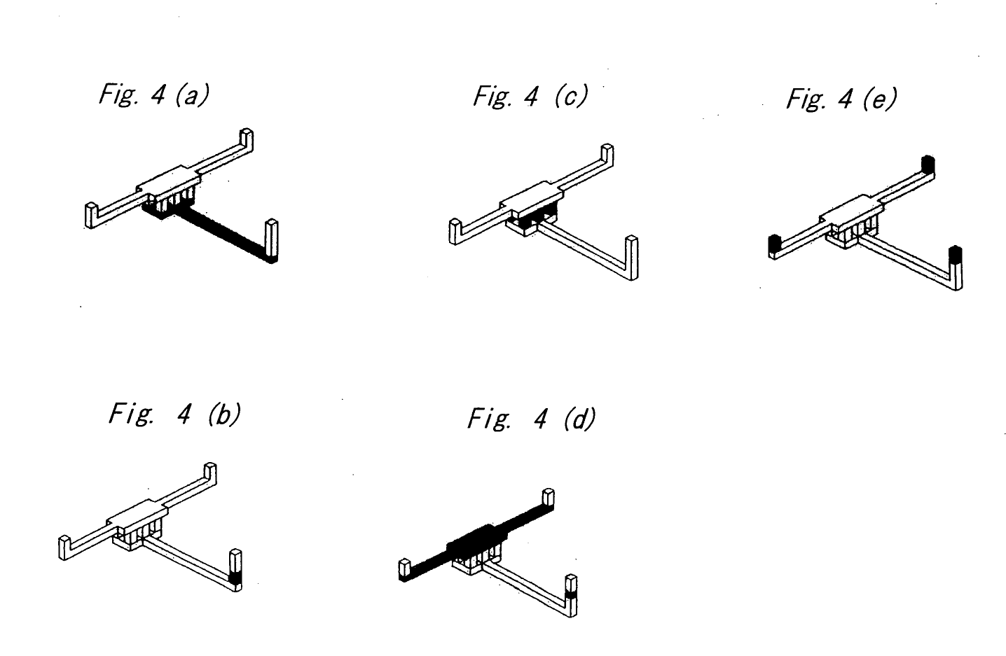

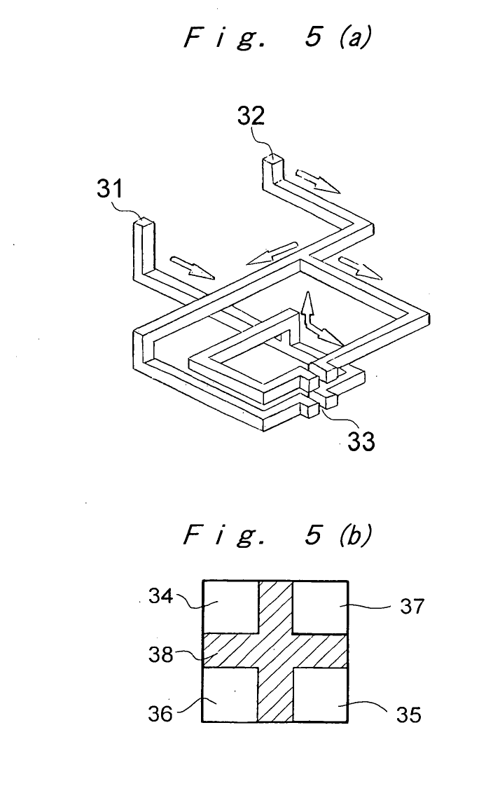

FIGS. 4(a) to 4(e) show processes for forming the micro channel. First, a groove shown by black of a first layer was formed in the film laminated on the glass by a laser in FIG. 4(a). Next, a film of a second layer was laminated, and a throughhole shown by black of the second layer, which passed through the groove of the first layer, was formed by a laser in FIGS. 4(b) and 4(c). Then, a film of a third layer was laminated, and a groove shown by black of the third layer and a throughhole shown by black, which passed through the hole of the second layer were formed by a laser in FIG. 4(d). Finally, a film of a fourth layer was laminated, and the micro channel was made by forming inlets and an outlet of the fourth layer by a laser, each colored black in FIG. 4(e).

### Example 2

A microfluidic device having a micro channel shown in FIG. 5(a) was made in the same manner as the example 1 except that the pattern formed by a laser was changed. In FIG. 5(a), reference numeral 31 denotes an inlet A, 32 denotes an inlet B, and 33 denotes a merge portion (inlet). The channel was continuous from the merge portion to an outlet (not shown). FIG. 5(b) shows the sectional view of the merge portion inlet 33. Reference numerals 34 and 35 denotes channels connecting to the inlet A, 36 and 37 denote channels connecting to the inlet B, and 38 denotes a resin layer.

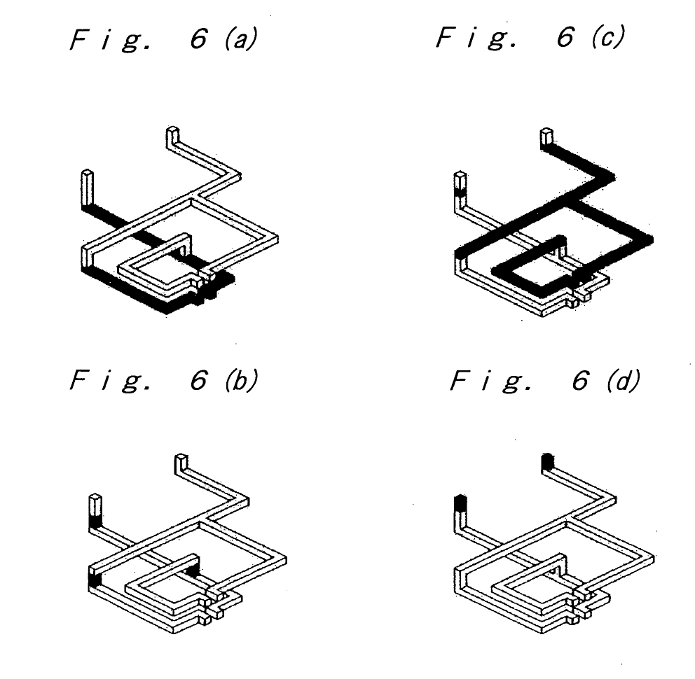

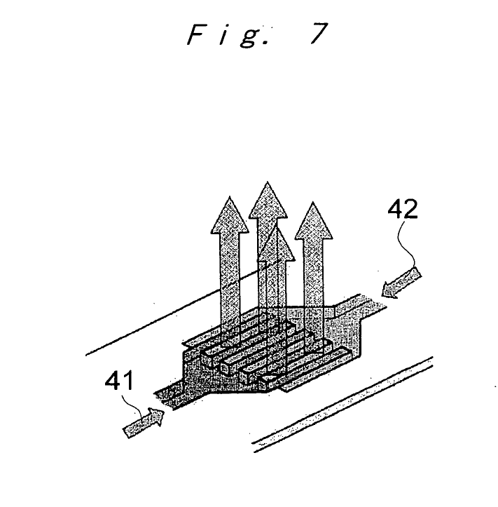

FIGS. 6(a) to 6(d) show processes for forming the micro channel. First, a groove shown by black of a first layer was formed in the film laminated on the glass by a laser in FIG. 6(a). Next, a film of a second layer was laminated, and a throughhole shown by black of the second layer, which passed through the groove of the first layer, was formed by a laser in FIG. 6(b). Then, a film of a third layer was laminated, and a groove shown by black of the third layer and a throughhole shown by black, which passed through the hole of the second layer were formed by a laser in FIG. 6(c). Finally, a film of a fourth layer was laminated, and the micro channel was made by forming inlets and an outlet of the fourth layer by a laser, each colored black in FIG. 6(d).

When the two channels in the merge portion formed in the film of the second layer were observed in a photograph taken by an optical microscope, the distance between the centers of the channels was 150 μm. The film was exfoliated in the portion sandwiched between the channels, and a wide channel was formed making use of the exfoliated portion. Further, another portions in which the groove was processed was exfoliated in the width of 140 μm. These exfoliated portions could be recovered by laminating a film of the subsequent layer, thereby wide channels could be formed using the exfoliated portions.

(Liquid Feed Experiments)

Next, experiments of feeding pure water to the channels formed in the examples 1 and 2 were executed. The pure water was fed using a minute amount micro pump (Ultra Plus II (trade name) manufactured by Micro-Tech Scientific Inc.) It was confirmed by the observation executed under a microscope that pure water, which was introduced from the inlet at the flow rate of 5 μl/min, passed through the merge portion and was discharged from the outlet in any of experiments. At the time, no damage such as exfoliation occurred in the channels.

When ink was introduced from the inlet A 21 in the micro-channel of the example 1 and pure water was introduced from the inlet B 22 thereof, they were mixed in the merge portion 23, and a uniformly mixed liquid lightly colored with the introduced ink was discharged from the outlet.

Further, it was observed that when ink was introduced from the inlet A in the micro-channel of the example 2 and pure water was introduced from the inlet B thereof also in the micro channel of the example 2, they were uniformly mixed in the merge portion.

It is shown by the above experiments that films can be laminated, the three-dimensional flow path circuit can be formed, and solutions can be satisfactorily mixed in the thus formed three-dimensional flow circuit in the manufacturing method of the present invention.

It is also shown that the film exfoliated by processing the groove can be recovered by laminating the film again, the flow path up to the groove width of 180 μm can be formed making use of exfoliation of the film.

Further, in the microfluidic device of the examples, no laminated film was exfoliated in the experiment of feeding pure water at the flow rate of 5 μl/min.

### INDUSTRIAL APPLICABILITY

The microfluidic device of the present invention is preferably used in the μ-TAS.

Further, the method of the present invention is particularly suitable for manufacturing the microfluidic device.

Having described our invention as related to the present embodiments, it is our intention that the invention not be limited by any of the details of the description, unless otherwise specified, but rather be construed broadly within its spirit and scope as set out in the accompanying claims.

1. A microfluidic device, comprising
a substrate;
a plurality of resin layers formed on the substrate; and
a three-dimensional fluid circuit formed in the plurality of the resin layers.

2. A method of manufacturing a microfluidic device, comprising the steps of:
(a) forming a resin layer on a substrate, and forming a groove having a predetermined pattern which functions as a fluid flow path by removing the resin layer by laser processing;
(b) forming a subsequent resin layer by coating a resin on the overall surface of the resin layer having been processed, and forming a groove and/or a throughhole to the groove formed in the resin layer coated with the resin, by laser processing of the subsequent resin layer;
(c) repeating the step (b); and
(d) forming a three-dimensional fluid circuit by finally forming inlets and an outlet by resin coating.

3. The method of manufacturing the microfluidic device according to claim 2, wherein the resin is formed by a lamination method.

4. The method of manufacturing the microfluidic device according to claim 2, wherein the resin layer is formed by a spin coat method.
